(19) United States
(12) Patent Application Publication
(10) Pub. No.: US 2004/0030995 A1
(43) Pub. Date: Feb. 12, 2004

(54) Web-based document printing and conversion

(75) Inventors: Kulvir Singh Bhogal, Fort Worth, TX (US); Nizamudeen Ishmael JR., Austin, TX (US)

Correspondence Address: Robert H. Frantz, P.O. Box 23324, Oklahoma City, OK, 73123, US

(73) Assignee: International Business Machines Corporation, Armonk, NY

(21) Appl. No.: 10/216,635

(22) Filed: Aug. 8, 2002

(51) Int. Cl. G06F 17/00

(52) U.S. Cl. 715/523

(57) ABSTRACT

A server-based computer file conversion, transcoding and virtual printing service available to users via a client computer using a web browser or microbrowser. The user may submit a file for conversion, indicate the source and destination file format, and subsequently receive a converted file or “printed” file from the service. The architecture of the invention allows for quick and easy incorporation of new converters, filters or transcoders without the need to distribute the converters to the client computers. Further, the invention allows vendors to provide converters and transcoders which are remotely accessible over a computer network from the conversion server.

### CROSS-REFERENCE TO RELATED APPLICATIONS (CLAIMING BENEFIT UNDER 35 U.S.C. 120)

Not applicable.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

Not applicable.

### BACKGROUND OF THE INVENTION

1. Field of the Invention

This invention relates to the arts of document conversion and printing, and especially to the arts of network-based application services for computer file conversion.

2. Background of the Invention

With the myriad of application programs available on the market place for personal computers and handheld devices, such as word processors, spreadsheets, browsers, personal information managers and organizers, etc., it has become very difficult and expensive for a user to be able to open, read, and modify all possible document types which he or she may receive or download. For example, there is a great deal of information available currently in Adobe Portable Document Format (“PDF”), Microsoft Word (“MSWord”), Tagged Information File (“TIF”), Extensible Markup Language (“XML”) and Hyper Text Markup Language (“HTML”). One might assume that if his or her computer were equipped Microsoft's [TM] Word wordprocessor for document files, Adobe's Acrobat [TM] Reader for PDF files, and a browser for TIFF, XML and HTML files, that he or she could open and read just about any file that may be downloaded or received by email.

However, there are still many other software products in use, and likely will continue to be in use for years to come, as no single product or family of products is likely to satisfy all possible customer's needs. Other common applications in use today which use their own proprietary format include, and which still enjoy considerable market share are (listed with their file extensions):

Lotus' SmartSuite [TM] including Lotus 1-2-3 [TM] spreadsheet (*.123), Organizer (*.org), WordPro [TM] (*.lwp) word processor and Freelance [TM] Graphics (*.prz);

Corel's WordPerfect [TM] (*.wpd) word processor, QuattroPro [TM] spreadsheet (*.wb3), and Draw graphics (.drw);

Adobe's Acrobat [TM] portable document format (*.pdf) rending software; and

Macromedia's tools for creating Flash files.

These are just a few of the types of files which one can encounter on a daily basis, and when one considers that each of these file types may also have multiple versions which are compatible with certain releases or versions of their associated application programs, and when one considers that these files may differ based upon the platform where they are created (e.g. personal computer with Microsoft Windows 95/98/NT/XP and CE, Linux, Apple Macintosh, Palm O/S, etc.), it is clear that there can be literally thousands of file types in the world at any given time.

Further, some of these files are persistent, so one must be prepared to encounter older or “legacy” file types, such as early versions of word processor files (WordStar), databases, spreadsheets, graphics, etc.

It is prohibitively expensive to attempt to own and maintain all the possible application programs that may be needed to at least open and/or print every type of file which may be encountered. One solution to this problem has been for certain types of application programs to provide import and export “filters” to allow opening and saving into other file types. For example, while Corel's WordPerfect [TM] word processor's native file type (*.wpd) is of a proprietary format, but Corel also provides a variety of “import filters” for many other file formats such as Microsoft's [TM] Word 97, OfficeWriter [TM], Windows Write [TM], WordStar [TM], AmiPro [TM], DisplayWrite [TM], and several “generic” formats such as Rich Text Format (“RTF”) and ASCII text. Similarly, a particular spreadsheet program may provide multiple import and export filters for other spreadsheet program file formats, and so on.

These importing and exporting filters are usually based upon the information regarding the proprietary file formats, which may be made publicly available by the other vendors of the programs. However, this typically does not usually include information about their latest and best features which provide their product with marketable advantages over their competitors' products.

For example, if a particular word processor vendor adds a feature to allow a user to edit moving or animated GIF objects within the word processing environment, their native file format would be improved to support this type of embedded object. But, this information would not be made publicly available in order protect the market position of the latest version of the word processor. As such, other word processor's import and export filters for that the file format would not correctly import or export those file features.

Additionally, many application programs allow users to set access and/or edit privilege passwords on their proprietary file formats. This “know-how”, though, is rarely made public, obviously to protect the security of the files created with the application program. So, even if a user has an import filter capable of opening a particular unprotected file type, he or she may be unable to do so if the file is password-protected.

So, with the cost of most of these applications ranging between several hundred dollars to several thousand dollars for “suites” of related applications, and with each set of related applications (e.g. Lotus Suite, Corel Office or Microsoft XP) requiring significant disk space for installation, it is impractical to maintain current copies of all application programs in order to open and/or print file types which may be encountered. For a corporation with a larger budget and networked-based storage, it may be feasible to obtain such a set of application programs, but the maintenance costs to periodically upgrade these programs can be considerable and prohibitive.

To attempt a solution to this problem, a number of file conversion applications have been brought to the market place, such as DataViz's ConversionsPlus application program. These utility programs are typically sold for installation on a client computer, and they offer conversion functions between hundreds of file types. Often, though, their capabilities lag the current feature levels of each file type by several releases of each application program. And, like the filters provided by the application program vendors, they don't usually support conversion of password-protected files, either. This being the case, most computer users do not buy such a conversion utility product, and many are unaware of their availability.

Therefore, there is a need in the art for a business service which provides quick, reliable and secure file conversion and/or printing on a basis which avoids the necessity of user or client maintaining expensive “copies” (e.g. properly licensed installations) of a plurality of application programs including word processors, graphics programs, photo and video editing software, web content authoring programs, spreadsheets, information managers, browsers, and databases.

Further, there is a need in the art for this new system to allow submission of original files and receipt of converted files and “printed” files through a common means, such as a web browser and the Internet.

### BRIEF DESCRIPTION OF THE DRAWINGS

The following detailed description when taken in conjunction with the figures presented herein provide a complete disclosure of the invention.

FIG. 1 depicts a generalized computing platform architecture, such as a personal computer, server computer, personal digital assistant, web-enabled wireless telephone, or other processor-based device, which can be used as a server device or a client device.

FIG. 2 shows a generalized organization of software and firmware associated with the generalized architecture of FIG. 1.

FIG. 3 sets forth the architecture of IBM's WebSphere Transcoding Publisher (“WTP”).

FIG. 4 illustrates the arrangement of computing systems according to a preferred embodiment of the invention.

FIG. 5 sets forth the logical process according to the invention.

### SUMMARY OF THE INVENTION

The present invention provides a server-based computer file conversion and virtual printing service available to users via a client computer such as a web browser or microbrowser. The user may submit a file for conversion, indicate the source and destination file format, and subsequently receive a converted file or “printed” file from the service. The architecture of the invention allows for quick and easy incorporation of new converters, filters or transcoders without the need to distribute the converters to the client computers. Further, the invention allows vendors to provide converters and transcoders which are remotely accessible over a computer network from the conversion server.

### DETAILED DESCRIPTION OF THE INVENTION

The invention is preferably realized as a feature or addition to the software already found present on such well-known computing platforms such as personal computers, web servers, and web browsers. These common computing platforms can include personal computers as well as portable computing platforms, such as personal digital assistants (“PDA”), web-enabled wireless telephones, and other types of personal information management (“PIM”) devices. These computing platforms may be used as a server, client, or both, according to the invention.

Therefore, it is useful to review a generalized architecture of a computing platform which may span the range of implementation, from a high-end web or enterprise server platform, to a personal computer, to a portable PDA or web-enabled wireless phone.

Computing Platform Details

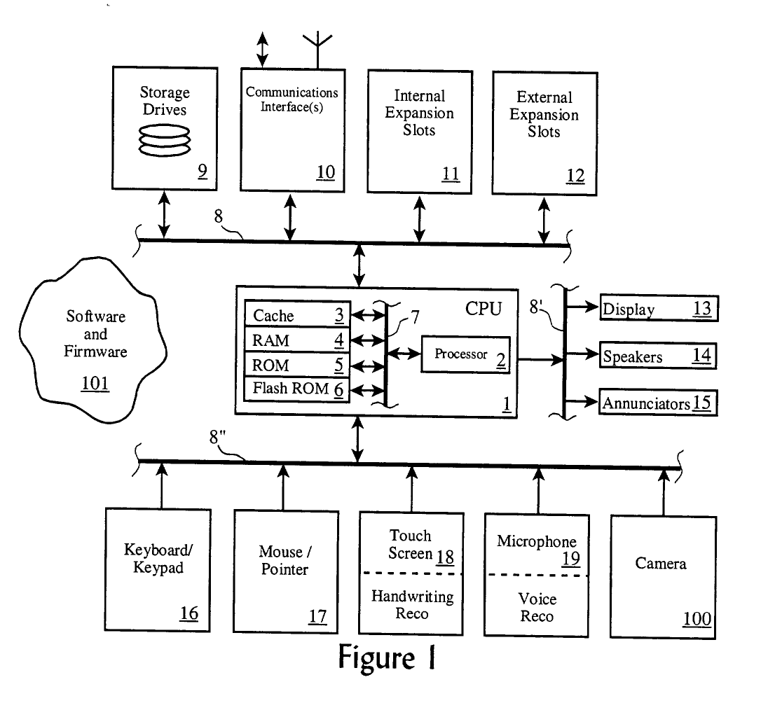

Turning to FIG. 1, a generalized architecture is presented including a central processing unit (1) (“CPU”), which is typically comprised of a microprocessor (2) associated with random access memory (“RAM”) (4) and read-only memory (“ROM”) (5). Often, the CPU (1) is also provided with cache memory (3) and programmable FlashROM (6). The interface (7) between the microprocessor (2) and the various types of CPU memory is often referred to as a “local bus” but also may be a more generic or industry standard bus.

Many computing platforms are also provided with one or more storage drives (9), such as a hard-disk drives (“HDD”), floppy disk drives, compact disc drives (CD, CD-R, CD-RW, DVD, DVD-R, etc.), and proprietary disk and tape drives (e.g., Iomega Zip [TM] and Jaz [TM], Addonics SuperDisk [TM], etc.). Additionally, some storage drives may be accessible over a computer network.

Many computing platforms are provided with one or more communication interfaces (10), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (IrDA) interface, too.

Computing platforms are often equipped with one or more internal expansion slots (11), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (12) allowing the user the ability to easily install and remove hardware expansion devices, such as PCMCIA cards, SmartMedia cards, and various proprietary modules such as removable hard drives, CD drives, and floppy drives.

Often, the storage drives (9), communication interfaces (10), internal expansion slots (11) and external expansion slots (12) are interconnected with the CPU (1) via a standard or industry open bus architecture (8), such as ISA, EISA, or PCI. In many cases, the bus (8) may be of a proprietary design.

A computing platform is usually provided with one or more user input devices, such as a keyboard or a keypad (16), and mouse or pointer device (17), and/or a touch-screen display (18). In the case of a personal computer, a full size keyboard is often provided along with a mouse or pointer device, such as a track ball or TrackPoint [TM]. In the case of a web-enabled wireless telephone, a simple keypad may be provided with one or more function-specific keys. In the case of a PDA, a touch-screen (18) is usually provided, often with handwriting recognition capabilities.

Additionally, a microphone (19), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (100), such as a still digital camera or full motion video digital camera.

One or more user output devices, such as a display (13), are also provided with most computing platforms. The display (13) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (14) and/or annunciators (15) are often associated with computing platforms, too. The speakers (14) may be used to reproduce audio and music, such as the speaker of a wireless telephone or the speakers of a personal computer. Annunciators (15) may take the form of simple beep emitters or buzzers, commonly found on certain devices such as PDAs and PIMs.

These user input and output devices may be directly interconnected (8′, 8″) to the CPU (1) via a proprietary bus structure and/or interfaces, or they may be interconnected through one or more industry open buses such as ISA, EISA, PCI, etc.

The computing platform is also provided with one or more software and firmware (101) programs to implement the desired functionality of the computing platforms.

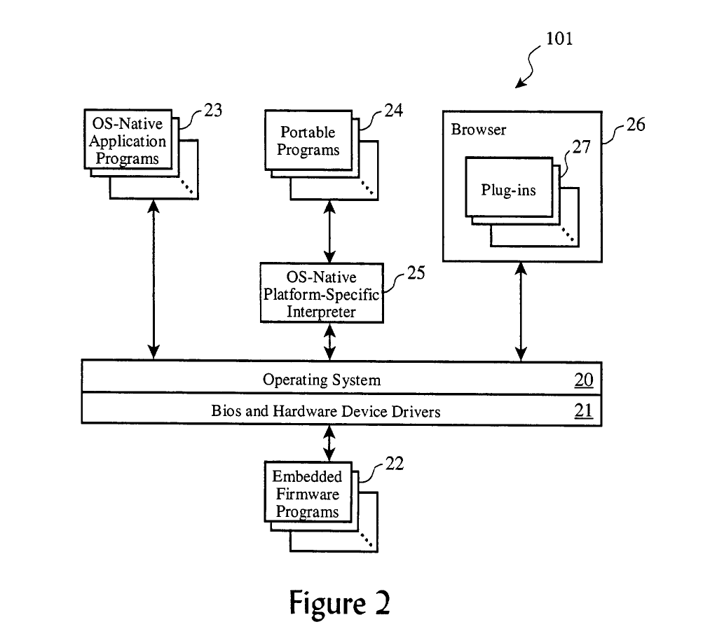

Turning to now FIG. 2, more detail is given of a generalized organization of software and firmware (101) on this range of computing platforms. One or more operating system (“OS”) native application programs (23) may be provided on the computing platform, such as word processors, spreadsheets, contact management utilities, address book, calendar, email client, presentation, financial and bookkeeping programs.

Additionally, one or more “portable” or device-independent programs (24) may be provided, which must be interpreted by an OS-native platform-specific interpreter (25), such as Java [TM] programs.

Often, computing platforms are also provided with a form of web browser or microbrowser (26), which may also include one or more extensions to the browser such as browser plug-ins (27).

The computing device is often provided with an operating system (20), such as Microsoft Windows [TM], UNIX, IBM OS/2 [TM], LINUX, MAC OS [TM] or other platform specific operating systems. Smaller devices such as PDA's and wireless telephones may be equipped with other forms of operating systems such as real-time operating systems (“RTOS”) or Palm Computing's PalmOS [TM].

A set of basic input and output functions (“BIOS”) and hardware device drivers (21) are often provided to allow the operating system (20) and programs to interface to and control the specific hardware functions provided with the computing platform.

Additionally, one or more embedded firmware programs (22) are commonly provided with many computing platforms, which are executed by onboard or “embedded” microprocessors as part of the peripheral device, such as a micro controller or a hard drive, a communication processor, network interface card, or sound or graphics card.

As such, FIGS. 1 and 2 describe in a general sense the various hardware components, software and firmware programs of a wide variety of computing platforms, including but not limited to personal computers, PDAs, PIMs, web-enabled telephones, and other appliances such as WebTV [TM] units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

Transcoding Publisher Details

According to the preferred embodiment, a server computing platform is provided with the IBM WebSphere Transcoding Publisher (“WTP”) software application, which is well known in the art. WTP is available for a variety of platforms and operating systems, including AS/400, Windows NT, Solaris, IBM AIX, and Linux. WTP is a networked server for translating existing web content, such as HTML and high-resolution JPEG graphics files, which is intended for transmission to client platforms having considerable processing and memory resources (e.g. a personal computer), to alternate file formats which are more appropriate for transmission to and use by resource-limited platforms, such as PDA's, web-enabled wireless phones, WebTV [TM], etc. For example, in order to accommodate the smaller screen sizes with fewer colors, minimized memory, and lower network bandwidth inherent with these types of client devices, documents are usually delivered in special, more compact formats such as Wireless Markup Language (“WML”), i-Mode, Compact HTML, VoiceHTML, XML, PalmOS HTML, etc. Graphics are usually restricted to low-resolution (e.g. GIF), and often to monochrome formats.

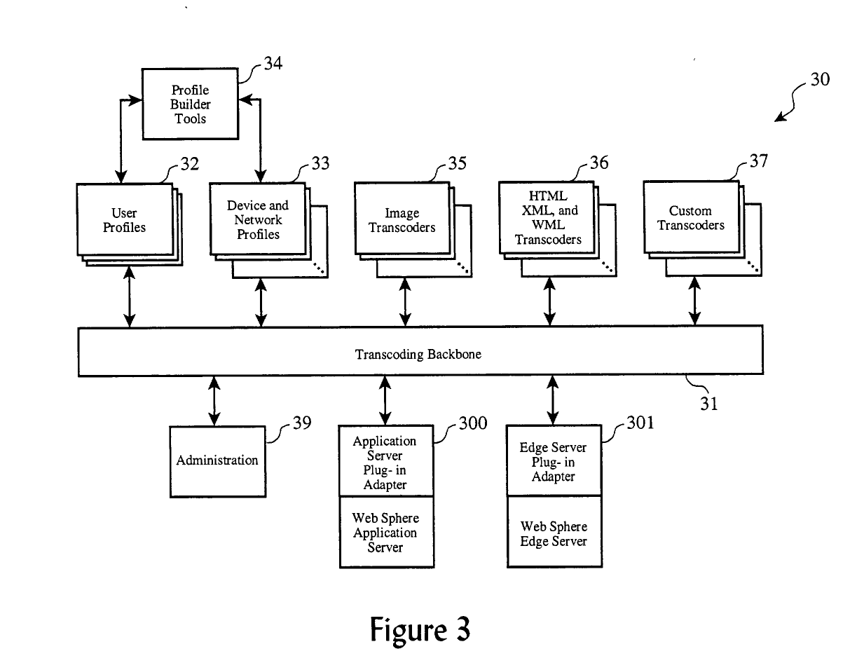

The WebSphere Transcoding Publisher can be deployed in a number of ways. Besides the stand-alone proxy server, caching proxy, servlet and JavaBeans [TM] transcoders, a reverse proxy deployment option can be selected. FIG. 3 shows the framework (30) of WTP, which includes a transcoding backbone (31), and administration console (39), and plug-in adapters for integrating to a WebSphere Application Server (300) and/or a WebSphere Edge Server (301). The transcoding backbone (31) also interfaces to a number of user profiles (32) and device and network profiles (33) which are used during a conversion process to determine the appropriate output file characteristics, as explained in more detail in the following paragraphs. A set of profile building and maintenance tools (34) are also provided with WTP to allow the creation and changing of user, device and network profiles.

One or more image transcoders (35), HTML and XML transcoders (36) and custom transcoders (37) are also supplied with an WTP installation. These transcoders are preferrably JavaBeans [TM], which allows the transcoders and the backbone to interface with each other using Java interfaces, and which facilitates remote interactions between the transcoders and the backbone. The transcoders do not have to reside on the same server, but may reside on a remote server from the backbone, such as a server operated by a transcoder vendor.

To understand the usual application of WTP, we turn to an example of a real-time transcoding application for browsing a standard web site by a wireless telephone. First, assume that the ABC wireless telephone network has a transmission capacity of 19.2 kbits per second, and that a Model XYZ wireless telephone is known to have a 200-dot by 400-dot monochrome display. As such, a network profile (33) for ABC telephone network and a device profile (33) for the XYZ model telephone may be created in the WTP system (30). Further, a particular user “Bob Smith” may have a user profile (32) which indicates he uses an XYZ model wireless telephone over the ABC telephone network.

When Bob Smith attempts to access a normal web page containing HTML and high resolution JPEG graphics, the WTP server accesses the user, network and device profiles, and determines the correct formats to which the HTML and JPEG files must be converted, such as WML and low resolution GIF. WTP (30) then accesses one or more image transcoders (35) and HTML transcoders (36) to perform the file translation. The translated files are then made available to the host server, which forwards them to the user's device for display.

IBM's WTP is system well-known in the art, whose technology is openly available from IBM. Transcoder developer kits are readily available for creating new transcoders, which allows the WTP framework (30) to be “open” to third party transcoders.

According to the preferred embodiment, the invention is realized by providing a computing platform with the WTP product, as just described, and with one or more “custom” transcoders which transcode from one application-native file format. While the original intent of WTP was to provide real-time web document translation, we use it in our invention to provide real-time server-based conversion of other types of documents, such as word processor files, spreadsheet files, etc. It is conceivable, too, that the invention may be used as a hybrid of the two application, such as converting word processor files to files directly viewable by a networked PDA (e.g. from MS Word *.doc format to WML format).

We now turn our attention to describing the method of the invention, which is preferrably realized as a Java Bean transcoder compatible with the WTP transcoder platform. It will be recognized by those skilled in the art that alternate embodiments may be made, such as use of an alternate transcoding platform, without departing from the spirit and scope of the present invention.

System Arrangement for Virtual Printing via Transcoding

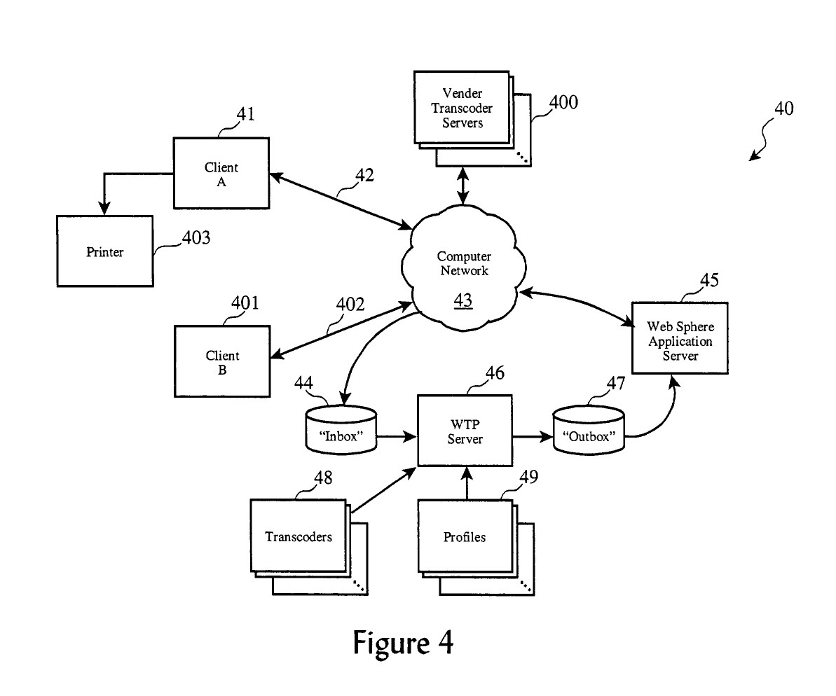

Turning to FIG. 4, the arrangement (40) of systems according to a preferred embodiment is shown. A user who has access to a first client computer (client A) (41) may wish to print a document file which he or she has received or downloaded.

In one embodiment, the document file can be uploaded to an “inbox” directory by the a web site application hosted by an application server (45), such as a WebSphere server. The application server would provide a set of user forms to indicate what type of file is being submitted, potentially including the version of the particular application which was used to create the file, and what type of file is desired.

For virtual “printing”, the target file type might be a “niversal” format which can be understood at the client side using a web browser, “freeware” reader, such as PDF, HTML, or RTF. Alternatively, the entire file could be transcoded to a printable image file, such as a JPEG or multi-page TIFF file, which would then be available to the client for printing (403). After the file has been uploaded, the application server can place the file for transcoding into the inbox (44). The application server may also create a temporary profile (49) for the deposited file to indicate the original file type and desired conversion file type. In another embodiment, a file for transcoding may be attached to an email and sent to a specific email WTP inbox (44).

The WTP server (46) is continuously “listening” to the inbox or monitoring it for newly arrived files, such as can be done with a Servlet/JSP arrangement. When a new file is detected in the inbox (44), an associated profile (49) is retrieved in order to determine which transcoder (48) should be employed for the transcoding. It is important to note that the transcoders (48) may be co-resident on the same computing platform as the WTP server (46), or they may be remotely accessible from other networked servers such as a vendors server. For example, Lotus could provide a link to a transcoder on their own servers for converting a wide variety of other file types to Lotus file types.

Also, a series of transcoders may be employed to obtain the desired target file type. For example, if the system does not contain a MS Word to Corel WordPerfect transcoder, it may use a Word-to-RTF transcoder first, and then apply an RTF-to WordPerfect transcoder second.

The transcoded file is placed in an outbox (47), which may be an actual email outbox directory such that the transcoded file may be emailed back to the client (41). Alternatively, the transcoded file may be placed in an outbox directory, from which the user may download it, preferrably in conjunction with the application running on the web server (45).

Once the transcoded file is received by the client (41), it may be printed (403) from the transcoded file format for which the client (41) machine is equipped with a compatible application program. Alternatively, the user may be allowed to specify having the transcoded file faxed to a certain fax number.

System Arrangement for Collaboration via Transcoding

In an alternate usage for the system, two users with incompatible software applications may use the invention to automatically transcode email attachments in transit between each other. For example, suppose that the first user's client computer (41) is equipped with Lotus WordPro wordprocessor, while the second user's or colleague's client computer (401) is equipped with Microsoft Word wordprocessor. Rather than finding a third file format which is acceptable for both users, they may configure the invention to transcode attached email files in transit.

The first user may obtain a WTP profile (49) which indicates his or her usual source file format and preferred conversion target format which is compatible with the colleague's software. With this arrangement, email attachments would be transcoded automatically on behalf of the user when he or she emails files to the colleague. Additionally, the colleague may obtain a profile (49) of his or her own for the first user, so that when the colleague emails attached files to the user, the reverse transcoding process is performed so that the user receives the attachment in his own native format.

File Transcoding Business Method

According to another aspect of the present invention, a business method is realized wherein the WTP server with custom application file transcoders as previously described is used to convert application files from one format to another over the Internet as an Application Service Provider (“ASP”). ASP's, or “apps-on-tap”, are companies which offer individuals or enterprises access over the Internet to applications and related services that would otherwise have to be located in their own personal or enterprise computers.

Using the WTP and methods of the present invention, an ASP could provide an alternative to its clients or customers to their having to purchase a wide array of application programs and/or file converters so that they can open and print a wide range of file types. In this model, the file conversion ASP can allow a customer to upload a document to the ASP's server, the customer is allowed to specify what type of document they are uploading and to select either printing or converting the file to another file format of interest, and the converted files can be transmitted back to the client.

The service could be provided on a time-based subscription basis (e.g. monthly fee), per-job basis (e.g. per page conversion fee), or on one-time batch basis. The latter may be especially valuable when a customer is changing from one company-wide suite of software to another, such as converting from all Microsoft Windows application to a Linux-based suite of applications.

As such, the ASP allows the customer to cost-effectively convert one or more files which they upload, and to download transcoded files in a format (or multiple formats) for which they have an application (or applications) that can open or print it. The ASP service may bear the costs of the necessary software application programs and transcoders, distributing the costs incrementally across all of the clients which need files converted.

Logical Process of the Invention

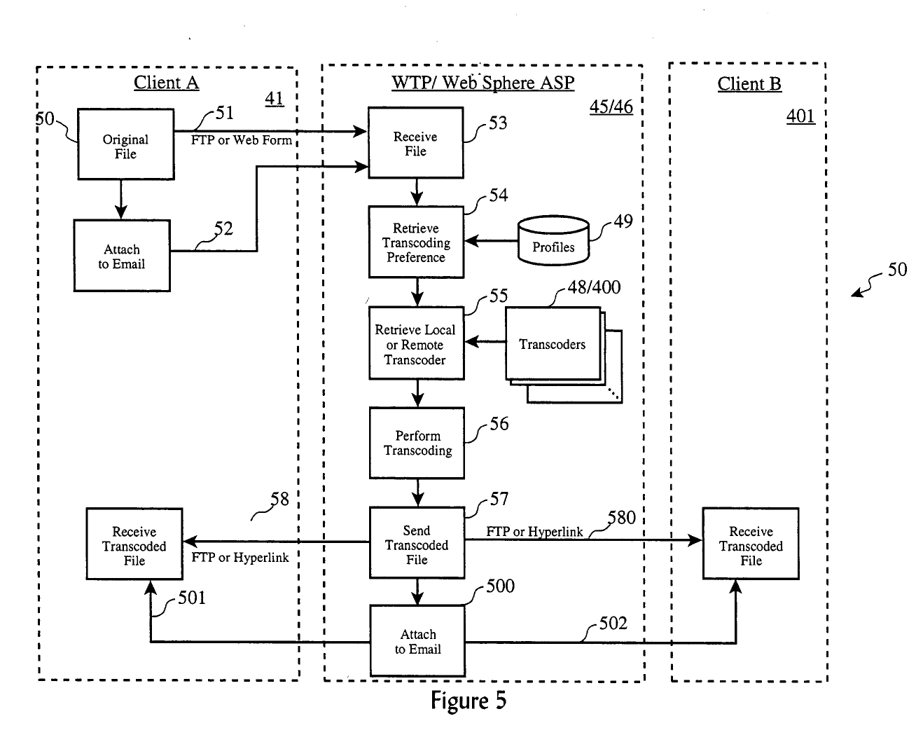

Turning to FIG. 5, the logical process (50) of the invention is shown. A first client (41) may transmit an original file (50) to the transcoder service (46), either by file transfer (51) or by email attachment (52).

The transcoder service (46) receives the file (53), retrieves (54) a transcoding preference, ideally from a profile (49), and retrieves (55) one or more transcoders (48/400), which may be locally stored or remotely accessible.

The transcoders are then invoked (56) on the original file (50), producing a transcoded file in the desired target format. This transcoded file may then be sent (57) back to the originating client (41), or to another client (401), either by file transfer (58, 580) or by email attachment (500, 501, 502).

### CONCLUSION

While a preferred embodiment has been set forth including certain programming details, methodology preferences, and computing platform preferences, it will be recognized by those skilled in the art that an array of alternate embodiments may be made without departing from the spirit and scope of the present invention. For example, alternate programming languages and methodologies may be employed to realize the process of the invention, as well as use of alternate transcoding software suites and computing platforms. Therefore, the scope of the present invention should be determined by the following claims.

What is claimed is:

1. A method of providing an electronic document and file conversion service comprising the steps of:
receiving from a submitter a computer file for conversion from a first application-native file format to a second file format;
selecting one or more transcoder programs according to a submitter preference;
processing said received file with said selected transcoder(s) to produce a transcoded file; and
providing the transcoded file to a recipient.

2. The method as set forth in claim 1 wherein said step of receiving a file comprises uploading a file to a designated server directory.

3. The method as set forth in claim 1 wherein said step of receiving a file comprises the steps of:
attaching the file for conversion to an electronic mail message; and
sending said electronic mail message and attached file to a transcoding service.

4. The method as set forth in claim 1 wherein said step of selecting one or more transcoder programs according to a submitter preference comprises selecting a transcoder to produce a readily printable file format.

5. The method as set forth in claim 1 wherein said step of providing the transcoded file to a recipient comprises the step of printing said transcoded file by said recipient.

6. The method as set forth in claim 1 wherein said step of providing the transcoded file to a recipient comprises the steps of:
attaching the transcoded file to an electronic mail message; and
sending said electronic mail message and attached file to said recipient.

7. The method as set forth in claim 1 wherein said step of providing the transcoded file to a recipient comprises downloading said transcoded file from a designated server directory.

8. A computer readable medium encoded with software for providing an electronic document and file conversion service, said software when executed by one or more computer servers performing the steps of:
receiving from a submitter a computer file for conversion from a first application-native file format to a second file format;
selecting one or more transcoder programs according to a submitter preference;
processing said received file with said selected transcoder(s) to produce a transcoded file; and
providing the transcoded file to a recipient.

9. The computer readable medium as set forth in claim 8 wherein said software for receiving a file from a submitter comprises software for uploading a file to a designated server directory.

10. The computer readable medium as set forth in claim 8 wherein said software for receiving a file from a submitter comprises software for performing the steps of:
attaching the file for conversion to an electronic mail message; and
sending said electronic mail message and attached file to a transcoding service.

11. The computer readable medium as set forth in claim 8 wherein said software for selecting one or more transcoder programs according to a submitter preference comprises software for selecting a transcoder to produce a readily printable file format.

12. The computer readable medium as set forth in claim 8 wherein said software for providing the transcoded file to a recipient comprises software for printing said transcoded file by said recipient.

13. The computer readable medium as set forth in claim 8 wherein said software for providing the transcoded file to a recipient comprises the software for performing the steps of:
attaching the transcoded file to an electronic mail message; and
sending said electronic mail message and attached file to said recipient.

14. The computer readable medium as set forth in claim 8 wherein said software for providing the transcoded file to a recipient comprises software for downloading said transcoded file from a designated server directory.

15. A system for electronic document and file conversion comprising:
a means for receiving a file and a conversion preference from a submitter, said submitted file being in a first application program native format, and said preference indicating a desired target file format;
a transcoder selector for selecting one or more transcoder programs according to said first application program native format and said preference;
a means for processing said received file using said selected transcoder(s) to produce a transcoded file in said desired target file format; and
a means for providing the transcoded file to a recipient.

16. The system as set forth in claim 15 wherein said means for receiving a file comprises a means for receiving an email attachment.

17. The system as set forth in claim 15 wherein said means for receiving a file comprises a means for monitoring and accessing a computer directory.

18. The system as set forth in claim 15 wherein said means for receiving a conversion preference comprises a profile for said submitter.

19. The system as set forth in claim 15 wherein said transcoder selector and said means for processing said received file using said selected transcoder(s) comprise an IBM WebSphere Transcoding Publisher platform and one or more transcoder beans.

20. The system as set forth in claim 15 wherein said means for providing the transcoded file to a recipient comprises a means for delivering said transcoded file by email attachment.

21. The system as set forth in claim 15 wherein said means for providing the transcoded file to a recipient comprises a means for delivering said transcoded file download.
